(19) United States
(12) Patent Application Publication
(10) Pub. No.: US 2013/0156943 A1
(43) Pub. Date: Jun. 20, 2013

(54) MICROCAPSULE COLOR-PATTERNING METHOD

(71) Applicant: Electronics & Telecommunications Research Inst, Daejeon (KR)

(72) Inventor: Kyung Soo Suh, Daejeon (KR)

(73) Assignee: Electronics and Telecommunications Research Institute, Daejeon (KR)

(21) Appl. No.: 13/707,663

(22) Filed: Dec. 7, 2012

(30) Foreign Application Priority Data
Dec. 14, 2011 (KR) 10-2011-0134356

(51) Int. Cl. B05D 1/28

(52) U.S. Cl. CPC B05D 1/286
USPC 427/162

(57) ABSTRACT

Provided is a color patterning method, in which electrophoretic microcapsules are used. The patterning method may include preparing a microcapsule slurry, in which electrophoretic microcapsules and a water-soluble binder are mixed, coating the microcapsule slurry on a first substrate, moving the microcapsules from the first substrate to a stamp, and moving the microcapsules from the stamp to a second substrate to form patterns. By using the patterning method, it is possible to form an intended pattern without physical and chemical damage on the microcapsules and realize an improved color electronic paper.

### CROSS-REFERENCE TO RELATED APPLICATIONS

This U.S. non-provisional patent application claims priority under 35 U.S.C. §119 to Korean Patent Application No. 10-2011-0134356, filed on Dec. 14, 2011, in the Korean Intellectual Property Office, the entire contents of which are hereby incorporated by reference.

### BACKGROUND OF THE INVENTION

Embodiments of the inventive concepts relate to a color-patterning method, and in particular, to a microcapsule color-patterning method applicable to electrophoretic displays.

A microcapsule may be used to realize flat-panel display devices. For example, a microcapsule-type electrophoretic display has been suggested as an electronic paper (e-paper). The microcapsule-type electrophoretic display may include a transparent electrode, a driving electrode, and microcapsules therebetween.

When an electric field is applied to the microcapsule-type electrophoretic display, some particles contained in the microcapsule may be moved toward an upper portion of the microcapsule. For example, white particles may be gathered around the upper portion of each microcapsule to display white, while black particles may be gathered and hidden around the lower portion of each microcapsule. When a direction of the electric field is reversed, the black particles may be displayed or seen. Due to bi-stability of the particles, a displayed image can be maintained, even when electric power is not supplied. As a result, there is no necessity to provide an additional light source in the display device. In addition, since an image on this display device can be read using reflection of a light like the conventional paper, it is possible to reduce power consumption thereof. Furthermore, because of high contrast ratio between black and white particles, this device can realize a clear image with a wide viewing angle. However, most of the commercialized electronic papers have been provided in the form of a black and white display that is applicable to limited applications.

In this sense, there have been several researches to develop a color electronic paper. For example, a color filter or a patterned color capsule may be used to realize the color electronic paper. However, most of previously suggested methods suffer from technical difficulties, such as high optical loss, low color contrast ratio, and lower reflectance, and thus, have failed to realize a vivid and clear color image.

### SUMMARY

Embodiments of the inventive concepts provide a method of forming patterns containing electrophoretic microcapsules on a substrate, without damage on the electrophoretic microcapsule.

According to example embodiments of the inventive concepts, a microcapsule color-patterning method may include preparing a microcapsule slurry, in which electrophoretic microcapsules and a water-soluble binder are mixed, coating the microcapsule slurry on a first substrate, moving the microcapsules from the first substrate to a stamp, and moving the microcapsules from the stamp to a second substrate to form patterns.

In example embodiments, the stamp may include a surface provided with patterned portions, and the moving of the microcapsules from the first substrate to the stamp may include moving the microcapsules from the first substrate to the patterned portions of the stamp.

In example embodiments, the coating of the microcapsule slurry may include forming the microcapsules in the form of line using a liquid ejector.

In example embodiments, the forming of the microcapsules in the form of line using the liquid ejector may include supplying the microcapsule slurry in the liquid ejector with an injection port and an ejecting hole, and coating the microcapsule slurry supplied in the liquid ejector onto the first substrate.

In example embodiments, the electrophoretic microcapsule may include at least one of a black particle, a white particle, or a color particle.

In example embodiments, the color particle may include one of a red particle, a green particle, and a blue particle.

In example embodiments, the water-soluble binder may include at least one of water-soluble urethane, water-soluble acryl, water-soluble ethylene-vinyl acetate (EVA) copolymer, acrylic resin, or polyvinyl alcohol.

In example embodiments, the coating of the microcapsule slurry on the first substrate may include coating the microcapsules on the first substrate to have a single-layered structure.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a flow chart illustrating a microcapsule color-patterning method according to example embodiments of the inventive concept.

FIG. 2A is a plan view illustrating an example of microcapsule slurry coated on a first substrate, according to the inventive concept.

FIG. 2B is a sectional view taken along a line A-A′ of FIG. 2A.

FIGS. 2C to 2E are a diagrams illustrating examples of microcapsule slurry coated on a substrate, according to the inventive concept.

FIG. 3A is a schematic diagram illustrating a process, in which microcapsules are ejected by a liquid ejector, according to example embodiments of the inventive concept.

FIG. 3B is a plan view illustrating microcapsule slurry coated on a substrate to form line patterns, according to the inventive concept.

FIG. 3C is a sectional view taken along a line A-A′ of FIG. 3B.

FIGS. 3D to 3F are diagrams illustrating examples of microcapsule slurry coated on a substrate to form line patterns, according to the inventive concept.

FIG. 3G is a plan view illustrating an example, in which three types of microcapsules are coated on a substrate to form line patterns, according to the inventive concept.

FIG. 3H is a sectional view taken along a line A-A′ of FIG. 3G.

FIG. 4A is a sectional view illustrating an example, in which microcapsules are moved onto a first stamp, according the inventive concept.

FIGS. 4B and 4C are diagrams illustrating examples, in which microcapsules are moved onto a second stamp, according to the inventive concept.

FIG. 5 is a sectional view of a color electronic paper according to a first embodiment of the inventive concept.

FIG. 6 is a sectional view of a color electronic paper according to a second embodiment of the inventive concept.

FIG. 7 is a sectional view of a color electronic paper according to a third embodiment of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

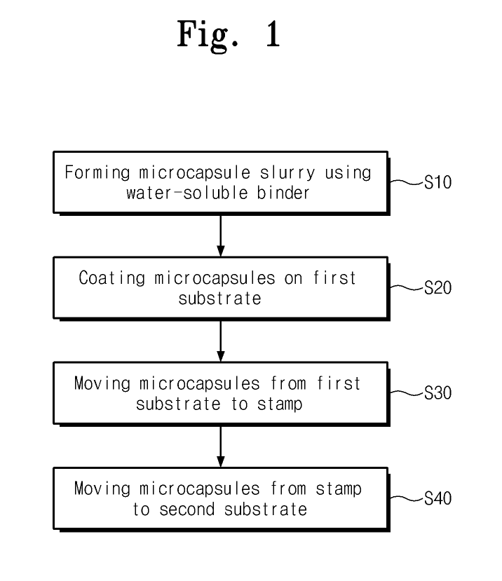

FIG. 1 is a flow chart illustrating a microcapsule color-patterning method according to example embodiments of the inventive concept.

Referring to FIG. 1, a microcapsule color-patterning method may include forming a microcapsule slurry using a water-soluble binder (in S10), coating monochromatic microcapsules on a glass substrate by a doctor blade method or a liquid ejector (in S20), moving some of the microcapsules, which may be selected to have a desired color, onto a stamp (in S30), and moving the microcapsules from the stamp to a patterned substrate to realize color pixels (in S40).

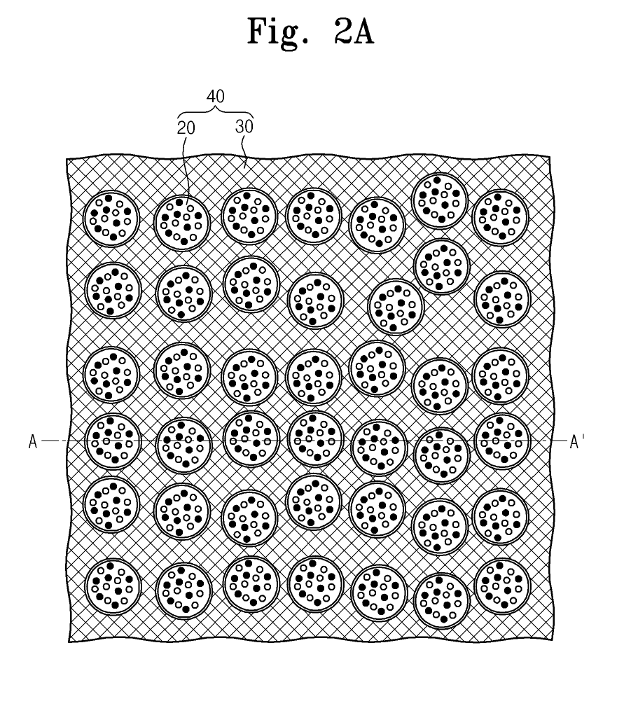

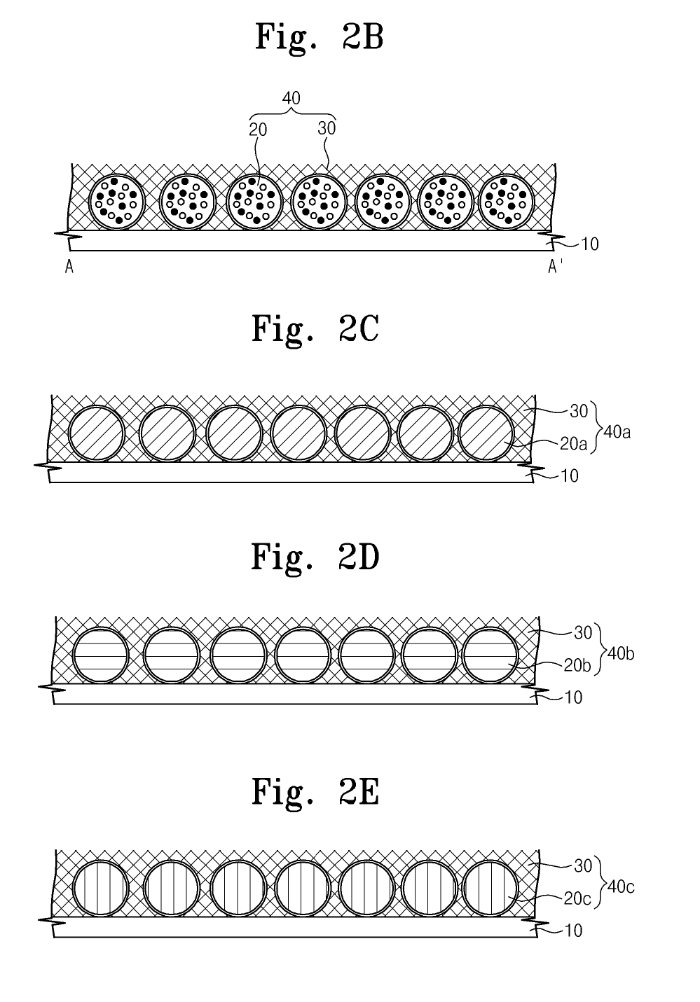

FIG. 2A is a plan view illustrating an example of microcapsule slurry coated on a first substrate, according to the inventive concept, and FIG. 2B is a sectional view taken along a line A-A′ of FIG. 2A.

Referring to FIGS. 1, 2A and 2B, microcapsule slurry 40 is prepared (in S10) and coated on a first substrate 10 (in S20). The coating of the microcapsule slurry 40 may be performed using a doctor blade method.

The microcapsule slurry 40 may include microcapsules 20 and a water-soluble binder 30. In example embodiments, the first substrate 10 may be a glass substrate and the microcapsules 20 may be configured to be applicable to an electrophoretic display. For example, each of the microcapsules 20 may include an outer wall and an interior element injected therein. In example embodiments, the interior element of the microcapsule 20 may include a bi-component material with liquid and solid particles. The particles may be electrically charged, and thus, they can be vertically moved by an electrophoresis technique. According to example embodiments of the inventive concept, an image may be realized based on this phenomenon. Each of the solid particles may be one of a color particle, a black particle, or a white particle. The outer wall of the microcapsule 20 may have a thickness of 0.1-0.3 μm and be formed of a polymer layer. In example embodiments, the microcapsules 20 on the first substrate 10 may have the same color or single color.

In the microcapsule slurry 40, the water-soluble binder 30 may have a weight percent of 5-20. The water-soluble binder 30 may be at least one of water-soluble urethane, water-soluble acryl, water-soluble ethylene-vinyl acetate (EVA) copolymer, acrylic resin, or polyvinyl alcohol. A process of mixing the microcapsules 20 with the water-soluble binder 30 may be performed while adjusting process parameters, such as viscosity of the water-soluble binder 30, a hydrophilic level, a curing temperature, and a curing time. In example embodiments, the water-soluble binder 30 may have a preferred hydrophilic level, when an organic solvent in the water-soluble binder 30 has 7 wt % or less.

In example embodiments, the water-soluble binder 30 may be a urethane binder. The microcapsule slurry 40 may include the water-soluble binder 30 mixed with 10 wt %.

In other embodiments, the microcapsule slurry 40 may be formed by mixing the water-soluble binder 30, a polyvinyl alcohol aqueous solution, and the microcapsules 20.

The water-soluble binder 30 may have about 10 wt %. The polyvinyl alcohol aqueous solution may be an aqueous solution of 10% polyvinyl alcohol. The aqueous solution of 10% polyvinyl alcohol may be mixed with about 10 wt %.

FIG. 2C to FIG. 2E are diagrams illustrating examples of microcapsule slurry coated on a substrate, according to the inventive concept.

Referring to FIG. 2C, first microcapsules 20a and a first microcapsule slurry 40a containing the water-soluble binder 30 may be coated on the first substrate 10. Each of the first microcapsules 20a may include at least one red particle and at least one white particle. Accordingly, the first microcapsule 20a may be used to display red.

Referring to FIG. 2D, a second microcapsule slurry 40b containing second microcapsules 20b and the water-soluble binder 30 may be coated on the first substrate 10. Each of the second microcapsules 20b may include at least one green particle and at least one white particle. Accordingly, the second microcapsule 20b may be used to display green.

Referring to FIG. 2E, a third microcapsule slurry 40c containing third microcapsules 20c and the water-soluble binder 30 may be coated on the first substrate 10. Each of the third microcapsules 20c may include at least one blue particle and at least one white particle. Accordingly, the third microcapsule 20c may be used to display blue.

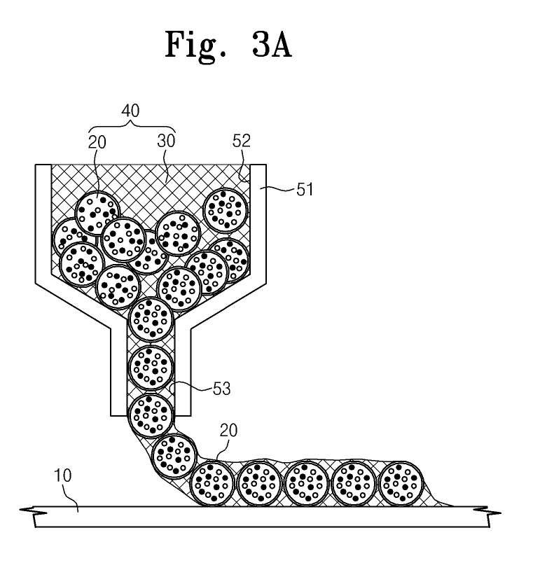

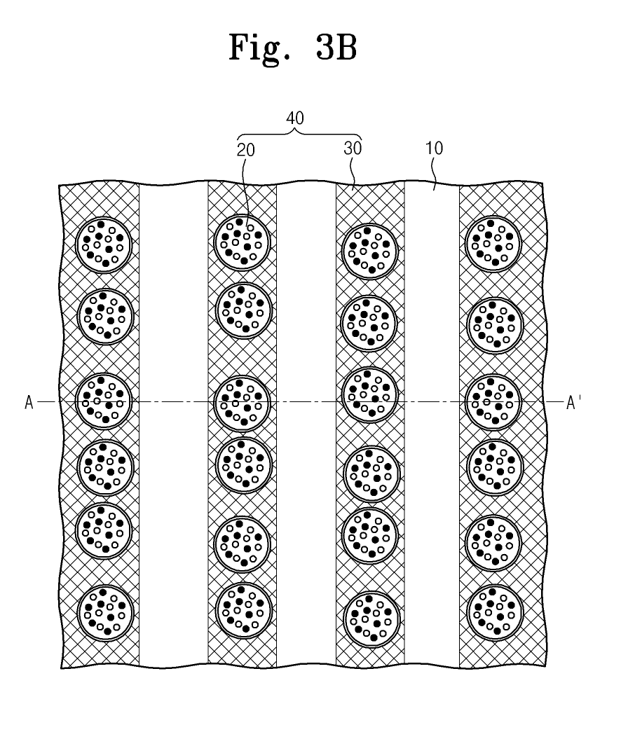

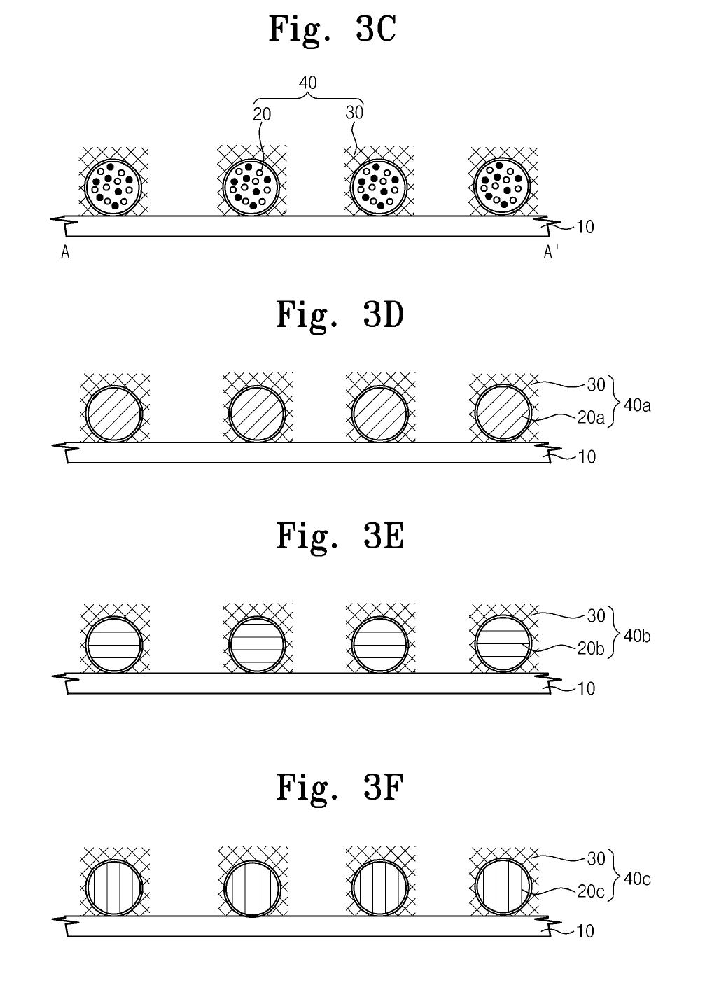

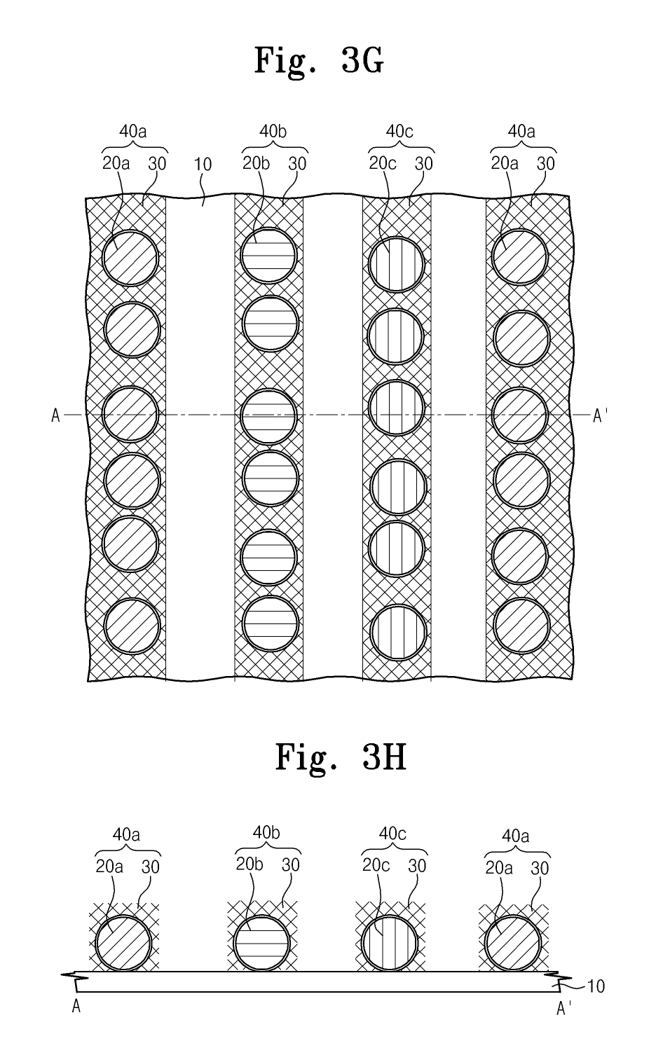

FIG. 3A is a schematic diagram illustrating a process, in which microcapsules are ejected by a liquid ejector, according to example embodiments of the inventive concept.

Referring to FIG. 3A, a liquid ejector 51 may include an injection port 52 and an ejecting hole 53. The microcapsule slurry 40 including the microcapsules 20 and the water-soluble binder 30 may be stored in the injection port 52. The microcapsule slurry 40 may be coated on the first substrate 10 through the ejecting hole 53. The liquid ejector 51 may be used to coat the microcapsules 20 in the microcapsule slurry 40 in the form of line.

FIG. 3B is a plan view illustrating microcapsule slurry coated on a substrate to form line patterns, according to the inventive concept, and FIG. 3C is a sectional view taken along a line A-A′ of FIG. 3B.

Referring to FIGS. 1, 3B and 3C, the microcapsule slurry 40 may be coated on the first substrate 10 to form line patterns that are spaced apart from each other with a specific distance (in S20). The coating process may be performed using the liquid ejector 51. In example embodiments, the microcapsules 20 may be coated on the substrate to have a single-layered structure. By using the liquid ejector 51, all microcapsules in each line pattern may have the same color.

FIGS. 3D to 3F are diagrams illustrating examples of microcapsule slurry coated on a substrate to form line patterns, according to the inventive concept.

Referring to FIGS. 3D to 3F, one of the first, second or third microcapsule slurries 40a, 40b, or 40c may be coated on the first substrate 10 to form line patterns that are spaced apart from each other with a specific distance.

For example, lines on the first substrate 10 may be formed of one of the first microcapsule slurry 40a containing the first microcapsules 20a, the second microcapsule slurry 40b containing the second microcapsule 20b, or the third microcapsule slurry 40c containing the third microcapsule 20c.

FIG. 3G is a plan view illustrating an example, in which three types of microcapsules are coated on a substrate to form line patterns, according to the inventive concept, and FIG. 3H is a sectional view taken along a line A-A′ of FIG. 3G.

Referring to FIGS. 3G and 3H, three types of microcapsule slurries 40a, 40b, and 40c may be coated to form line patterns that are spaced apart from each other with a specific distance. In example embodiments, the three types of microcapsule slurries 40a, 40b, and 40c may be sequentially coated in specific order. For example, the first microcapsule slurry 40a containing the first microcapsules 20a may be coated in the form of line, and the second microcapsule slurry 40b containing the second microcapsule 20b may be coated to form line patterns, each of which may be spaced apart from the lines of the first microcapsule slurry 40a, and thereafter, the third microcapsule slurry 40c including the third microcapsule 20c may be coated to form line patterns, each of which may be spaced apart from the lines of the second microcapsule slurry 40b. The above process may be repeated one or more times to form a pattern. In example embodiments, the pattern formed by the above process may serve as pixels. The coating process may be performed using the liquid ejector 51.

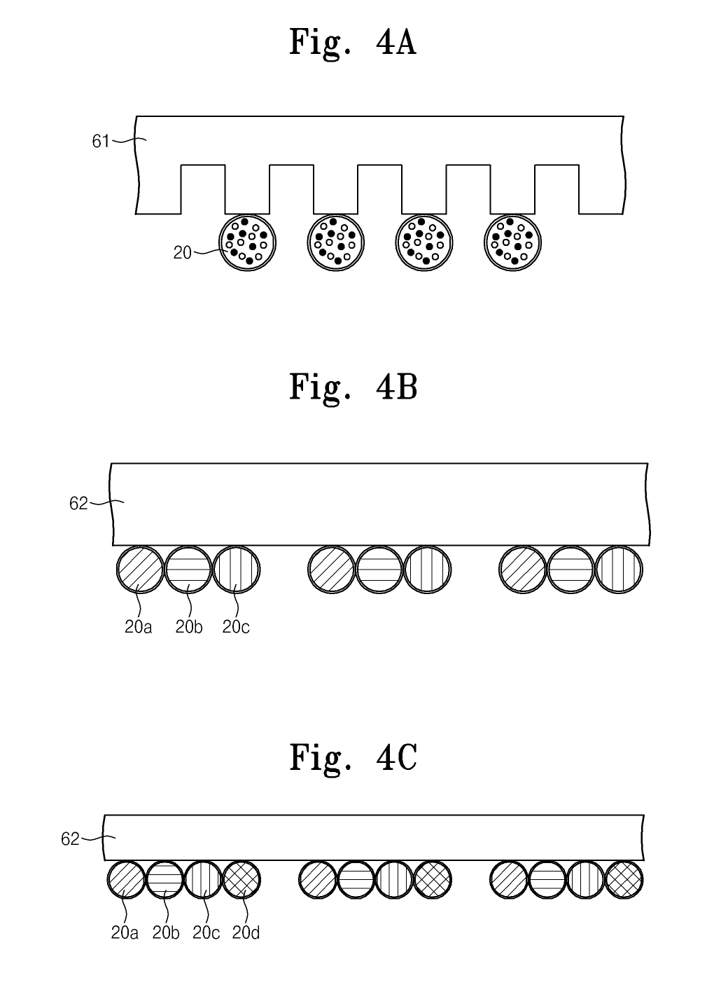

FIG. 4A is a sectional view illustrating an example, in which microcapsules are moved onto a first stamp, according the inventive concept, and FIG. 4B is a diagram illustrating examples, in which microcapsules are moved onto a second stamp, according to the inventive concept.

Referring to FIGS. 1, 4A, 4B and 4C, the microcapsules coated on the first substrate 10 may be moved onto surfaces of first and second stamps 61 and 62 (in S30).

Referring to FIG. 4A, the first stamp 61 may include patterned portions. The microcapsules 20 on the first substrate 10 may be selectively moved onto the first stamp 61.

For example, in the case where microcapsules of the same type are coated on the first substrate 10 as shown in FIG. 2C, they may be selectively moved onto the patterned portions of the first stamp 61.

In the case where the movement is performed using a stamp method, one or more capsule may be moved onto a stamp, depending on a size of the microcapsule 20. Here, to prevent the microcapsule 20 from being detached from the stamp, the stamp may have a modified surface.

Referring to FIGS. 4B and 4C, the second stamp 62 may be formed not to have a patterned portion. In example embodiments, a patterned single-layered structure disposed on the first substrate 10 may be all moved on the second stamp 62 (in S30). For example, in the case where the microcapsules 20a, 20b, and 20c are provided in a patterned form on the first substrate 10 as shown in FIG. 3H, they may be moved on a surface of the second stamp 62. The patterned single-layered structure to be moved onto the second stamp 62 may include three or four types of microcapsules. In the case where the pixel of RGB type is required, the patterned single-layered structure may be configured to include three types of microcapsules. In the case where the pixel is configured to have a pentile structure, the patterned single-layered structure may be configured to include four types of microcapsules.

The three types of microcapsules may consist of the first microcapsule 20a, the second microcapsule 20b, and the third microcapsule 20c. In example embodiments, the first, second, and third microcapsules 20a, 20b, and 20c may be configured to display red, green, and blue, respectively. The four types of microcapsules may consist of the first microcapsule 20a, the second microcapsule 20b, the third microcapsule 20c, and a fourth microcapsule 20d. For example, in the case of a RGBG-type pentile structure, the fourth microcapsule 20d may include at least one white particle and at least one green particle, thereby displaying green. In the case of a RGBW-type pentile structure, the fourth microcapsule 20d may include at least one white particle and at least one black particle.

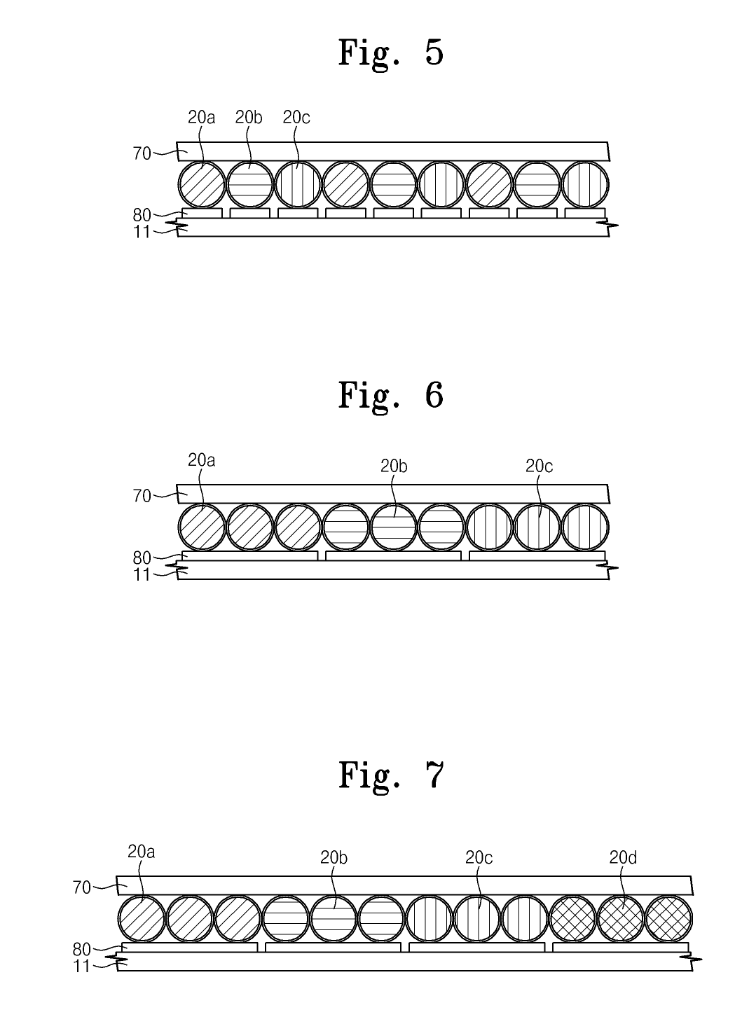

FIG. 5 is a sectional view of a color electronic paper according to a first embodiment of the inventive concept. Referring to FIGS. 1 and 5, the first microcapsule 20a, the second microcapsule 20b, and the third microcapsule 20c may be moved on a pixel electrode 80 of a second substrate 11 to form a color pattern (in S40). The color pattern may be used to form a color pixel. The microcapsules may be selectively moved onto the pixel electrode 80 using the first stamp or be moved in such a way that the patterned single-layered structure may be wholly moved using the second stamp. In example embodiments, the color electronic paper may be configured to include RGB-type pixels.

Referring to FIG. 5, the color electronic paper may include the second substrate 11, the pixel electrodes 80, the first microcapsule 20a, the second microcapsule 20b, the third microcapsule 20c, and a transparent electrode 70. Each of the first microcapsule 20a, the second microcapsule 20b, and the third microcapsule 20c may be disposed on the corresponding one of the pixel electrodes 80, thereby constituting a sub pixel. For example, each pixel may consist of three sub pixels. The transparent electrode 70 may be provided on the first microcapsule 20a, the second microcapsule 20b, and the third microcapsule 20c. The transparent electrode 70 may be formed of a conductive transparent material. An electric field may be applied to the microcapsules 20a, 20b, and 20c, respectively, via the pixel electrode 80.

FIG. 6 is a sectional view of a color electronic paper according to a second embodiment of the inventive concept. Referring to FIG. 6, the color electronic paper may include the second substrate 11, the pixel electrodes 80, the first microcapsule 20a, the second microcapsule 20b, the third microcapsule 20c, and the transparent electrode 70. In example embodiments, a plurality of microcapsules may be moved on each of the pixel electrodes 80. The microcapsules may be selectively moved onto the pixel electrode 80 using the first stamp or be moved in such a way that the patterned single-layered structure may be wholly moved using the second stamp. In example embodiments, the color electronic paper may be configured to include RGB-type pixels.

A plurality of microcapsules provided on each pixel electrode 80 may constitute a sub pixel. For example, each pixel may consist of three types of sub pixels. In other embodiments, each pixel may consist of three types of sub pixels, which may include the first microcapsules 20a, the second microcapsules 20b, and the third microcapsules 20c, respectively. The first microcapsule 20a may be configured to display red, the second microcapsule 20b may be configured to display green, and the third microcapsule 20c may be configured to display blue.

In example embodiments, each of the first microcapsule 20a, the second microcapsule 20b, and the third microcapsule 20c may have an outer wall made of a soft polymer layer. Accordingly, the microcapsules may have a deformed shape, which may be different from that depicted in the drawings, between the electrodes.

FIG. 7 is a sectional view of a color electronic paper according to a third embodiment of the inventive concept.

Referring to FIG. 7, the color electronic paper may include the second substrate 11, the pixel electrode 80, the first microcapsule 20a, the second microcapsule 20b, the third microcapsule 20c, the fourth microcapsule 20d, and the transparent electrode 70. In example embodiments, a plurality of microcapsules may be moved on each of the pixel electrodes 80. The microcapsules may be selectively moved onto the pixel electrode 80 using the first stamp or be moved in such a way that the patterned single-layered structure may be wholly moved using the second stamp. In example embodiments, the color electronic paper may be configured to include pentile-type pixels.

A plurality of microcapsules provided on each pixel electrode 80 may constitute a sub pixel. In the case of the pentile-type pixels, each pixel may consist of two sub pixels. In the case of the RGBG-type pentile structure, one of the pixels may consist of sub pixels displaying red and green (RG) or displaying blue and green (BG). In the case of the RGBW-type pentile structure, one of the pixels may consist of sub pixels displaying red and green (RG) or displaying blue and white (BW).

For example, one of the pixels may consist of a sub pixel containing the first microcapsules 20a and a sub pixel containing the second microcapsules 20b. Alternatively, one of the pixels may consist of a sub pixel containing the third microcapsules 20c and a sub pixel containing the fourth microcapsules 20d. The first microcapsule 20a may be configured to display red, and the second microcapsule 20b may be configured to display green. The third microcapsule 20c may be configured to display blue. The fourth microcapsule 20d may be configured to display green or white, according to the pentile structure.

An electric field may be applied to the microcapsules 20a, 20b, 20c, and 20d, respectively, via the pixel electrode 70 and the transparent electrode 60. The outer walls of the microcapsules 20a, 20b, 20c, and 20d may be made of a soft polymer layer, and thus, the microcapsules may have a deformed shape, which may be different from that depicted in the drawings, between the transparent electrode 60 and the pixel electrode 70.

According to example embodiments of the inventive concept, a stamp may be used to form a color pattern containing microcapsules, and thus, the microcapsules may be prevented from being physically or chemically damaged. This enables to apply a predetermined voltage to a substrate, without damage on the microcapsule.

In other words, by using the microcapsule color-patterning method according to example embodiments of the inventive concept, it is possible to form an intended pattern without physical and chemical damage on the microcapsules. This enables to prevent pixels from being deteriorated.

While example embodiments of the inventive concepts have been particularly shown and described, it will be understood by one of ordinary skill in the art that variations in form and detail may be made therein without departing from the spirit and scope of the attached claims.

What is claimed is:

1. A microcapsule color-patterning method, comprising:
preparing a microcapsule slurry, in which electrophoretic microcapsules and a water-soluble binder are mixed;
coating the microcapsule slurry on a first substrate;
moving the microcapsules from the first substrate to a stamp; and
moving the microcapsules from the stamp to a second substrate to form patterns.

2. The method of claim 1, wherein the stamp comprises a surface provided with patterned portions, and
the moving of the microcapsules from the first substrate to the stamp comprises moving the microcapsules from the first substrate to the patterned portions of the stamp.

3. The method of claim 1, wherein the coating of the microcapsule slurry comprises forming the microcapsules in the form of line using a liquid ejector.

4. The method of claim 3, wherein the forming of the microcapsules in the form of line using the liquid ejector comprises:
supplying the microcapsule slurry in the liquid ejector with an injection port and an ejecting hole; and
coating the microcapsule slurry supplied in the liquid ejector onto the first substrate.

5. The method of claim 1, wherein the electrophoretic microcapsule comprises at least one of a black particle, a white particle, or a color particle.

6. The method of claim 5, wherein the color particle comprises one of a red particle, a green particle, and a blue particle.

7. The method of claim 1, wherein the water-soluble binder comprises at least one of water-soluble urethane, water-soluble acryl, water-soluble ethylene-vinyl acetate (EVA) copolymer, acrylic resin, or polyvinyl alcohol.

8. The method of claim 1, wherein the coating of the microcapsule slurry on the first substrate comprises coating the microcapsules on the first substrate to have a single-layered structure.
